(19) United States
(12) Patent Application Publication
(10) Pub. No.: US 2026/0083271 A1
(43) Pub. Date: Mar. 26, 2026

(54) Pour-Over Coffee Maker with Zero Bypass Brewing Chamber

(71) Applicant: SMITH & LEACOCK LLC, Brownsburg, IN (US)

(72) Inventors: Park Leacock, Brownsburg, IN (US); Zachary Smith, Fort Wayne, IN (US)

(73) Assignee: SMITH & LEACOCK LLC, Brownsburg, IN (US)

(21) Appl. No.: 19/314,651

(22) Filed: Aug. 29, 2025

Related U.S. Application Data
(60) Provisional application No. 63/697,852, filed on Sep. 23, 2024.

(51) Int. Cl. A47J 31/10; A47J 31/06

(52) U.S. Cl. CPC A47J 31/10; A47J 31/06

(57) ABSTRACT

The coffee maker comprises an upper reservoir with an upper opening, a middle opening of smaller diameter, and a sloped sidewall tapering downwardly and inwardly from the upper opening to the middle opening. A brewing chamber disposed below is fluidly connected to the upper reservoir. The brewing chamber has a lower sidewall that extends from the middle opening to a discharge opening disposed at the bottom. The upper reservoir facilitates the controlled pour of hot water over ground coffee disposed in the brewing chamber. The brewing chamber ensures enhanced flavor extraction from the brewed coffee with little to no bypass. The design of the upper reservoir and brewing chamber enhances and expedites the brewing process, making the coffee maker ideal for coffee enthusiasts seeking a high-quality pour-over coffee experience.

### CROSS REFERENCES

This application is a non-provisional, which claims the benefit of U.S. Provisional Application No. 63/697,852, entitled “Pour-Over Coffee Maker with Zero Bypass Brewing Chamber”, and filed on 23 Sep. 2024, which is incorporated herein by reference in its entirety.

### REFERENCE TO RESEARCH

Not Applicable.

### REFERENCE TO CDS

Not Applicable.

### FIELD OF THE INVENTION

The present disclosure relates to a portable, pour-over apparatus for making and dispensing beverages, the apparatus has an upper receiver that receives poured liquid at a position higher than a brewing chamber placed on top of a beverage container.

### BACKGROUND

Coffee drinking has never been more popular. Many people drink coffee throughout the day, whether at home, at work, or at play. The ability to make coffee conveniently and/or in a particular style is becoming increasingly important to consumers. A coffee drinker might wish to tailor the style of making the coffee to suit the grind. Two popular styles of making coffee are with a press coffee maker or a pour-over coffee maker.

For example, some coffee drinkers believe press coffee is preferable with a course grind. A press coffee maker, such as a French Press, involves placing ground coffee into a cannister or container, such as a carafe made of glass, steel, plastic, or the like. The cannister is filled with hot water, allowing the ground coffee to steep in the hot water for a period of time. A filter is then slid down the cannister to sequester the spent grounds at the bottom of the cannister so the steeped coffee can be poured out the top of the cannister. Alternatively, the filter may be placed at the bottom of a press coffee maker and a plunger slid down the cannister to push the steeped coffee out the bottom of the cannister.

Some coffee drinkers believe pour-over is preferable with a fine grind. With a pour-over coffee maker, ground coffee is placed in a cone shaped funnel that is positioned above a container. The ground coffee is separated from the funnel by a filter. Hot water is poured over the ground coffee by moving a hand pot from the center to the outer edge in a spiral manner, and then moving in reverse back to the center to soak the ground coffee. The ground coffee will bloom in contact with the hot water and cause a release of carbon dioxide. The coffee flavor is infused into the hot water which then passes through the filter and into the container as a coffee beverage. A pour-over type coffee maker is one in which the coffee is brewed by a single or repeated pass of hot water through a quantity of ground coffee.

### SUMMARY

In some aspects, the pour-over coffee maker apparatus has: (a) an upper reservoir having: (i) an upper opening; (ii) a middle opening having a diameter that is less than a diameter of the upper opening; (iii) a sloped sidewall that tapers downwardly and inwardly from the upper opening to the middle opening; (b) a brewing chamber disposed below and fluidly connected with the upper reservoir, the brewing chamber having: (i) a discharge opening disposed at the bottom of the brewing chamber, the discharge opening having: (1) a diameter that is equal to or greater than the diameter of the middle opening; (ii) a lower sidewall extending downwardly from the middle opening of the upper reservoir to the discharge opening of the brewing chamber; (iii) a volume corresponding to between 1 to 10 times the volume of a single size of coffee grounds; (iv) a volume corresponding to between 20 cubic centimeters (cm³) to 120 cm³; (c) an exterior sidewall that tapers downwardly and inwardly from the upper opening to the discharge opening; and (d) a filter retainer mounted to the discharge opening structured to receive and retain a disc-shaped filter.

In some aspects, the pour-over coffee maker apparatus is structured to: (a) insulate the upper reservoir and the brewing chamber; (b) removably mount the brewing chamber with the upper reservoir; (c) drain a poured liquid from the upper reservoir and the discharge opening of the brewing chamber under the force of gravity; and (d) extract the poured liquid through the brewing chamber at an increased liquid flow rate relative to the liquid flow rate of the liquid flowing into and out of the brewing chamber;

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 depicts an elevation view of a side profile of a pour-over coffee maker apparatus.

FIG. 2 depicts a perspective view of a top side of the apparatus shown in FIG. 1.

FIG. 3 depicts a perspective view of a bottom side of the apparatus shown in FIG. 1.

FIG. 4 depicts the elevation view of the apparatus shown in FIG. 1 in cross section.

FIG. 5 depicts a perspective view of a side profile of a pour-over coffee maker apparatus.

### DETAILED DESCRIPTION

The pour-over coffee maker apparatus has an upper reservoir with an upper opening of larger diameter, a middle opening of smaller diameter, and a sloped sidewall that tapers downwardly and inwardly from the upper opening to the middle opening. A brewing chamber may be structured to fluidly connect and/or removably mount with the upper reservoir. The brewing chamber may have a volume of 1 to 10 times greater than the volume of a single serving size of ground coffee (approx. between 20 cubic centimeters (cm³) to 120 cm³). The bottom of the brewing chamber has a discharge opening. The discharge opening has a diameter that is equal to or greater than the diameter of the middle opening. A filter retainer may be removably mounted within the discharge opening. The filter retainer can retain a filter that may be disc shaped. A lower sidewall of the brewing chamber extends from the middle opening to the discharge opening. An exterior sidewall may taper downwardly and inwardly from the upper opening to the discharge opening so that the apparatus is insulated.

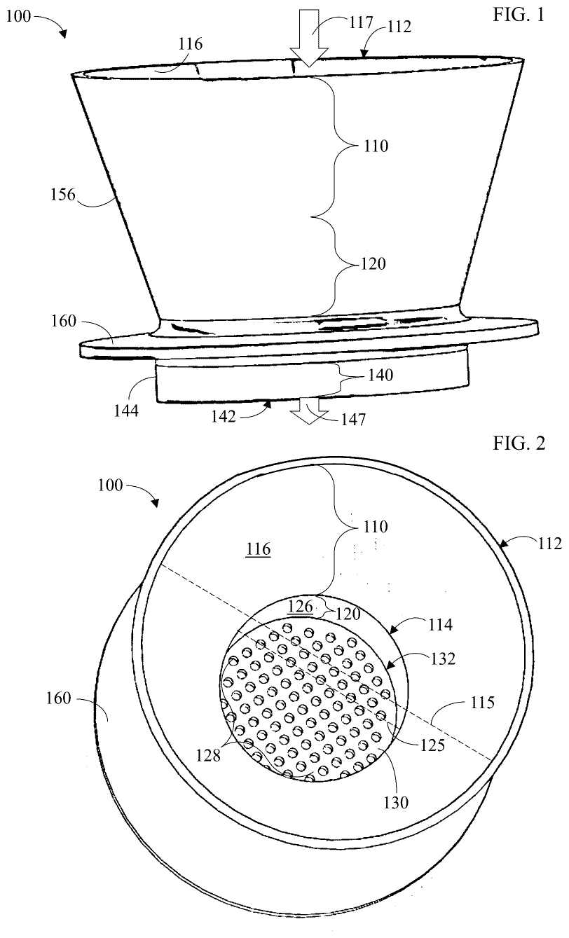

FIG. 1 depicts an elevation view of a side profile of a pour-over coffee maker apparatus-hereinafter referred to as “apparatus”—that can make any number of varied drink beverages, hot or cold. Apparatus 100 comprises an upper reservoir 110 and a lower reservoir hereinafter referred to as a brewing chamber 120. The upper reservoir 110 and brewing chamber 120 are disposed on an interior of apparatus 100. Apparatus 100 has an upper opening 112 and a discharge opening 142. The upper opening 112 is structured to receive a poured liquid into upper reservoir 110. Discharge opening 142 is structured to dispense an extracted liquid from brewing chamber 120. An exterior sidewall 156 may taper downwardly and inwardly from the upper opening 112 towards the discharge opening 142 which gives an upper portion of apparatus 100 a truncated cone shape.

An exterior seat 160 disposed on an exterior of apparatus 100 may define a boundary between the brewing chamber 120 and a discharge portion 140. Exterior seat 160, may be an annular lip, collar or ledge, that extends outwardly and horizontally from exterior sidewall 156. Exterior seat 160 may be structured to function as a seat for apparatus 100. Placing discharge portion 140 into a beverage container will allow exterior seat 160 to sit upon a rim of the beverage container to support apparatus 100 while a liquid solution dispenses from apparatus 100 into the beverage container.

FIG. 2 depicts a perspective view of a top side of apparatus 100 shown in FIG. 1. A sloped sidewall 116 tapers downwardly and inwardly within upper reservoir 110 from the upper opening 112 to a middle opening 114. Upper opening 112 and middle opening 114 may have annular shapes. Sloped sidewall 116 may encircle upper reservoir 110 between the upper opening 112 and middle opening 114. Sloped sidewall 116 directs a poured liquid from the upper opening 112 of upper reservoir 110 towards the middle opening 114. At the middle opening 114, a middle diameter 125 of apparatus 100 is less than an upper diameter 115 of apparatus 100 disposed at the upper opening 112.

Upper diameter 115 of apparatus 100 may be between 2.5 inches and 10 inches in diameter. Upper diameter 115 may be further between 3 inches and 9 inches in diameter, between 3 inches and 8 inches in diameter, between 3 inches and 7 inches in diameter, between 4 inches and 9 inches in diameter, between 4 inches and 8 inches in diameter, between 4 inches and 7 inches in diameter, between 4 inches and 6 inches in diameter, between 5 inches and 10 inches in diameter, between 5 inches and 9 inches in diameter, between 5 inches and 8 inches in diameter, between 5 inches and 7 inches in diameter, between 5 inches and 6 inches in diameter, or approximately 5 inches in diameter.

Middle diameter 125 of apparatus 100 may be between 0.25 of an inch and 3.75 inches in diameter. Middle diameter 125 may be further between 0.5 of an inch and 3.5 inches in diameter, between 0.75 of an inch and 3.25 inches in diameter, between 1 inch and 3 inches in diameter, between 1.25 inches and 2.75 inches in diameter, between 1.5 inches and 2.5 inches in diameter, between 1.75 inches and 2.75 inches in diameter, between 2 inches and 3 inches in diameter, between 2.25 inches and 3.25 inches in diameter, between 2.5 inches and 3.5 inches in diameter, or approximately 2.5 inches in diameter.

A lower sidewall 126 extends vertically downward from a bottom end of sloped sidewall 116. Lower sidewall 126 may be perpendicularly inclined relative to horizontal. Lower sidewall 126 may encircle brewing chamber 120 between the middle opening 114 and the discharge opening 142. Lower sidewall 126 may terminate in contact with a filter retainer 130 disposed at a bottom end of brewing chamber 120.

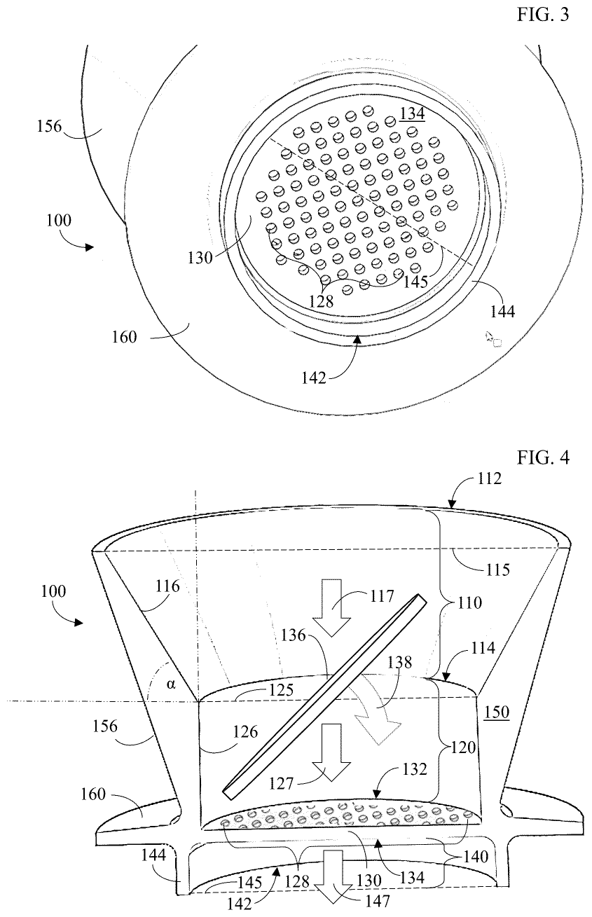

FIG. 3 depicts a perspective view of a bottom side of apparatus 100 shown in FIG. 1. Discharge opening 142 is seen disposed below the filter retainer 130 when viewing the interior of apparatus 100 from a bottom side. Discharge opening 142 may have an annular shape like the upper opening 112 and middle opening 114. At the discharge opening 142, a lower diameter 145 of apparatus 100 may be equal to or greater than the middle diameter 125 of apparatus 100 disposed at the middle opening 114.

Lower diameter 145 of apparatus 100 may be between 0.25 of an inch and 5 inches in diameter. Lower diameter 145 may be further between 0.5 of an inch and 4.5 inches in diameter, between 0.75 of an inch and 4.25 inches in diameter, between 1 inch and 4 inches in diameter, between 1.25 inches and 3.75 inches in diameter, between 1.5 inches and 3.5 inches in diameter, between 1.75 inches and 3.75 inches in diameter, between 2 inches and 3.5 inches in diameter, between 2.25 inches and 3.25 inches in diameter, between 2.5 inches and 3.5 inches in diameter, between 2.75 inches and 3.75 inches in diameter, or approximately 2.75 inches in diameter.

FIG. 4 depicts the elevation view of apparatus 100 shown in FIG. 1 with the interior of apparatus 100 shown in cross section. Upper reservoir 110 may have a conical shape by sloped sidewall 116 extending downwardly and inwardly from upper opening 112 to middle opening 114. Brewing chamber 120 is fluidly connected to a bottom end of upper reservoir 110, in which the fluid connection may be seamless. Brewing chamber 120 may have a cylindrical shape by lower sidewall 126 extending vertically downward from middle opening 114 to discharge opening 142. Middle diameter 125 may be less than both upper diameter 115 and lower diameter 145 which makes brewing chamber 120 a constricted section of apparatus 100. Such constriction may cause a reduction in the fluid pressure and increase the velocity of the moving liquid passing through the brewing chamber 120. Discharge portion 140 is fluidly connected to a bottom end of brewing chamber 120.

Increased throughput of liquid—hereinafter referred to as “extraction rate 127”—may occur within brewing chamber 120. Fluid dynamics may increase the extraction rate 127 within apparatus 100 so that the brew time decreases by between 10% and 50% over existing manual coffee brewers. The extraction rate 127 of apparatus may decrease the brew time further between 15% and 45%, further between 20% and 40%, further between 25% and 35%, or further between 30% and 35% over existing manual coffee brewers, such as the AeroPress or the Hario V60 coffee makers. In testing, apparatus outperformed AeroPress by reducing the brew time by 33% (e.g. 3-minute brew time for AeroPress coffee maker vs. 2-minute brew time for apparatus). Additionally, the outflow rate 147 of apparatus was found to have a continuous, steady flow versus the intermittent, irregular flow of the V60 coffee maker.

The filter retainer 130 may define a boundary between the brewing chamber 120 and discharge portion 140 of apparatus 100. Filter retainer 130 may be structured to mount within apparatus 100 to function as a floor of brewing chamber 120. Filter retainer 130 may be disc-shaped to fit compatibly within brewing chamber 120 that is cylindrical. Filter retainer 130 may have an outer perimeter that fits within an inner perimeter of the lower sidewall 126 encircling the brewing chamber 120. Filter retainer 130 may be mounted with lower sidewall 126 disposed within brewing chamber 120. Alternatively, filter retainer 130 may be mounted with a discharge wall 144 disposed within discharge portion 140. Discharge portion 140 may have a cylindrical shape by discharge wall 144 extending vertically downward and encircling discharge opening 142 in a lower portion of apparatus 100.

Filter retainer 130 may be a removable insert structured to be seated upon an interior seat, such as an annular lip, collar or ledge. The interior seat may extend inwardly and horizontally from lower sidewall 126 above discharge opening 142. Alternatively, the interior seat may extend inwardly and horizontally from discharge wall 144 into discharge opening 142.

As shown in FIG. 4, a filter 136 that is removable may be deposited upon an upper retainer surface 132 of filter retainer 130 (see movement arrow 138) via the middle opening 114. Filter 136 may be any type of single-use or reusable filter made of steel, paper, or other micro-filter type material. An outside perimeter of filter 136 may fit within an inner perimeter of lower sidewall 126 encircling the brewing chamber 120. Filter 136 may be disc shaped to fit compatibly within brewing chamber 120 that is cylindrically shaped. In one example, the filter 136 diameter is comparable to a standard sized AeroPress type micro-filter which is 2.5 inches (approx. 63 millimeters) in diameter. In another example, the filter 136 diameter is comparable to a larger sized AeroPress type micro-filter that is approx. 3 inches (approx. 73 millimeters) in diameter.

A granulated or non-granulated material for making the beverage may be deposited upon filter 136 received and retained by filter retainer 130. Alternatively, the beverage source material may be deposited directly upon the filter retainer 130. Brewing chamber 120 that is cylindrical causes the beverage source material deposited in apparatus 100 to form into a puck shaped, cylindrical mass. Alternatively, the geometric shape of brewing chamber 120 may be cubic, rectangular, or other prismatic shape. The integrity of the bedded material is preserved by brewing chamber 120. Brewing chamber 120 contains agitation during throughput of the poured liquid so that there is uniformity in extraction.

The volume of the brewing chamber 120 may be between 20 cm³ to 120 cm³. In one example, the volume of the brewing chamber 120 may correspond to between 1 to 10 times the volume of a single serving size of ground coffee (approx. 10 grams to 30 grams of ground coffee, or approx. 2 tablespoons of ground coffee).

The cylinder height of brewing chamber 120, relative to the diameter of brewing chamber 120, may be equal to or greater than a height of a single serving size of ground coffee. The cylinder height may be between 0.25 of an inch to 4 inches. The cylinder height may be further between 0.5 of an inch and 3 inches, between 0.75 of an inch and 2 inches, between 1 inch and 2 inches, or approx. ⅞ of an inch.

Still referring to FIG. 4, structure within the interior of apparatus 100 is designed to drain a poured liquid, under the force of gravity with even distribution, from the upper reservoir 110 into the beverage source material contained within brewing chamber 120. Sloped sidewall 116 is shown disposed interior to exterior sidewall 156. Sloped sidewall 116 may be sloped at an angle (α) relative to horizontal so that the poured liquid is directed into the brewing chamber 120 that is fluidly connected to upper reservoir 110. In one example, the angle (α) of sloped sidewall 116 may be 55° relative to horizontal. In another example, the angle (α) of sloped sidewall 116 may be 65° relative to horizontal. In yet another example, the angle (α) of sloped sidewall 116 is 60° relative to horizontal.

The angle (α) of sloped sidewall 116 may be between 25° and 85° relative to horizontal. The angle (α) of sloped sidewall 116 may be further between 45° and 85°, between 40° and 80°, between 35° and 75°, between 30° and 70°, between 25° and 65°, between 20° and 60°, between 55° and 85°, between 50° and 80°, between 45° and 75°, between 30° and 60°, between 25° and 55°, between 65° and 85°, between 60° and 80°, between 55° and 75°, between 50° and 70°, between 45° and 65°, between 40° and 60°, between 35° and 55°, between 30° and 50°, between 25° and 45°, between 75° and 85°, between 70° and 80°, between 65° and 75°, between 60° and 70°, between 55° and 65°, between 50° and 60°, between 45° and 55°, between 40° and 50°, between 35° and 55°, between 30° and 40°, or further between 25° and 35°, the angle ranges being relative to horizontal.

Apparatus 100 is structured to extract the poured liquid with increased velocity through the brewing chamber 120. The poured liquid pools within upper reservoir 110 under the force of gravity and enters the brewing chamber 120 at an inflow rate 117 that may be less than the velocity of an extraction rate 127. Pressure induced by weight of the pooled liquid within upper reservoir 110 may push downstream liquid through the beverage source material bedded within brewing chamber 120 at the extraction rate 127. An extracted liquid discharges out of the brewing chamber at an outflow rate 147 under the force of gravity.

A plurality of discharge apertures 128 may be disposed through filter retainer 130 from the upper retainer surface 132 to a lower retainer surface 134 of filter retainer 130. The plurality of discharge apertures 128 allow the extracted liquid to be released from the brewing chamber 120 into discharge opening 142. Discharge opening 142 is disposed at the bottom of brewing chamber 120. Discharge opening 142 may be encircled by a discharge wall 144 that descends vertically downward from the lower retainer surface 134 within discharge portion 140. Discharge wall 144 may extend vertically downward from lower sidewall 126. Alternatively, discharge wall 144 may descend vertically downward from exterior seat 160. Discharge wall 144 may direct the extracted liquid discharged from the brewing chamber 120 into a beverage container disposed below the discharge opening 142.

The upper reservoir 110 and brewing chamber 120 may be insulated to maintain the temperature of a hot liquid poured through apparatus 100. Exterior sidewall 156 tapers downwardly and inwardly from the upper opening 112 to the discharge opening 142 that gives apparatus 100 an overall truncated cone shape when viewed from the exterior. However, an internal space 150 may be disposed between the exterior sidewall 156 and the interior sidewalls, that is the sloped sidewall 116 and lower sidewall 126. Internal space 150 may be structured to function as an insulating layer. Internal space 150 provides a thickened barrier between the liquid solution disposed within apparatus 100 and the exterior of apparatus 100 which may be in contact with ambient air or a hand of the user. Internal space 150 may be a double-walled cavity devoid of air, such as a vacuum-sealed space. Alternatively, internal space 150 may be occupied with an insulating material such as air, gas, liquid, or other fluid. Alternatively, internal space 150 may be filled with the same material that the apparatus 100 is made of, with or without insulating pockets or cavities.

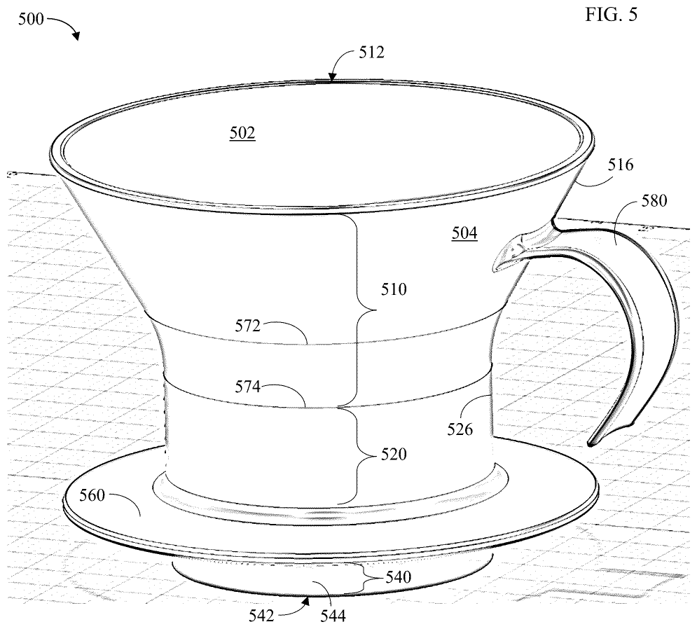

FIG. 5 depicts a perspective view of a side profile of another example of the apparatus. Apparatus 500 can make any number of varied drink beverages, hot or cold. Apparatus 500 comprises an upper reservoir 510 and a brewing chamber 520. Upper reservoir 510 may have a conical shape. Brewing chamber 520 may have a cylindrical shape. The upper reservoir 510 and brewing chamber 520 are disposed within an interior of apparatus 500. Apparatus 500 has an upper opening 512 and a discharge opening 542. The upper opening 512 is structured to receive a poured liquid into upper reservoir 510. Discharge opening 542 is structured to dispense an extracted liquid from brewing chamber 520.

A sloped sidewall 516 tapers downwardly and inwardly from the upper opening 512 towards the discharge opening 542. Sloped sidewall 516 of upper reservoir 510 directs a poured liquid from the upper opening 512 towards the brewing chamber 520. A lower sidewall 526 of brewing chamber 520 descends vertically downward from a bottom end of sloped sidewall 516. Lower sidewall 526 may terminate at a horizontal boundary defined by a filter retainer disposed at a bottom end of brewing chamber 520. Alternatively, lower sidewall 526 may terminate at discharge opening 542 disposed at a bottom end of apparatus 500.

An exterior seat 560 disposed on an exterior surface 504 of apparatus 500 may define a boundary between brewing chamber 520 and a discharge portion 540. Exterior seat 560, may be an annular lip, collar or ledge, that extends outwardly and horizontally from the exterior surface 504 below the brewing chamber 520. Exterior seat 560 may be structured to function as a seat for apparatus 500. Placing discharge portion 540 into a beverage container will allow exterior seat 560 to sit upon a rim of the beverage container to support apparatus 500 while a liquid solution dispenses from discharge opening 542 into the beverage container. Discharge portion 540 may have a cylindrical shape by a discharge wall 544 extending vertically downward and encircling discharge opening 542 in a lower portion of apparatus 500.

As shown in FIG. 5, an upper horizontal groove 572 and a lower horizontal groove 574 are disposed on the exterior surface 504 of apparatus 500. The upper horizontal groove 572 and lower horizontal groove 574 may serve as design elements on apparatus 500 for aesthetic purposes. In addition to, or separate from the exterior surface 504, upper horizontal groove 572 and lower horizontal groove 574 may be disposed on an interior surface 502 of apparatus 500. The lower horizontal groove 574 might be utilized by a user of apparatus 500 as a first indicator fill line for a beverage source material, such as ground coffee. The upper horizontal groove 572 might be utilized by a user of apparatus 500 as a second indicator fill line for a poured liquid, such as heated water. In the case of brewing coffee within apparatus 500, a cylindrical mass of ground coffee may be placed in brewing chamber 520 up to lower horizontal groove 574. The puck of ground coffee may bloom by pouring a first portion of a heated liquid up to the upper horizontal groove 572. The upper horizontal groove 572 may be positioned anywhere on the exterior surface 504 and/or interior surface 502 within the upper reservoir 510 section. The lower horizontal groove 574 may be positioned anywhere on the exterior surface 504 and/or interior surface 502 within the brewing chamber 520 section.

The lower portion of apparatus 500 may be structured to be removably mounted with the upper portion of apparatus 500. In one example, brewing chamber 520 may be removably mounted with upper reservoir 510 at lower horizontal groove 574. A screw thread design having compatible internal and external threads between upper reservoir 510 and brewing chamber 520 may be utilized for the removability feature. Alternatively, a snap-on configuration, or other attachment design between upper reservoir 510 and brewing chamber 520 might be utilized.

A curved handle 580 may be mounted upon exterior surface 504 to provide a user with a convenient method to transport, turn over, or otherwise assist the user to move apparatus 500.

Any appropriate manufacturing process, such as pressing, blowing, casting, molding, injection molding, or other forming techniques may be used to produce this pour-over coffee maker apparatus. The apparatus may be made with durable materials such as ceramics, synthetic polymers like silicone, stainless steel or aluminum, plastics including polypropylene or polyethylene, glass which may include borosilicate, or other food-safe or food-grade material that is compatible with the liquid intended for use in the apparatus.

Liquid beverages made by this apparatus may include any type of liquid beverage, hot or cold, including coffee, expresso, mocha, tea, chai, cider, tinctures, herbal extracts, chocolate drinks, dairy beverages, alcoholic beverages, synthetic drinks, and fruit or vegetable beverages. Various raw materials, natural and/or synthetic, may be sourced and utilized in the apparatus to make the liquid beverage. Various source materials for the production of beverages include leaves, pluckings, cuttings, grounds, powders, fines, or other drink materials that are ground or sieved may be bedded in the brewing chamber of the apparatus for extraction.

The practical design and functional structure of this apparatus may enhance fluid dynamics by utilizing the Venturi effect, especially in making coffee. The upper reservoir may facilitate the poured liquid to pool and then push downstream liquid into the ground coffee bed in the brewing chamber disposed below. The poured liquid may move through the ground coffee bed with increased velocity and extraction, but with reduced or zero bypass of the poured liquid. The poured liquid is evenly extracted across and through the coffee bed within the brewing chamber while the extracted coffee discharges through the discharge opening under the force of gravity. Coffee brews extracted by the apparatus were found have enhanced flavors and aromas over existing pour-over coffee maker brews while being made more quickly, efficiently, and cheaply. A user of this apparatus may experience increased value with coffee purchases because less ground coffee may be used with the standard amount of water, or less, per serving of coffee.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

We claim:

1. A pour-over coffee maker apparatus comprising:
an upper reservoir comprised of:
an upper opening;
a middle opening having a diameter that is less than a diameter of the upper opening;
a sloped sidewall that tapers downwardly and inwardly from the upper opening to the middle opening;
a brewing chamber disposed below and fluidly connected with the upper reservoir, the brewing chamber comprised of:
a discharge opening disposed at a bottom of the brewing chamber; and
a lower sidewall extending downwardly from the middle opening of the upper reservoir to the discharge opening of the brewing chamber.

2. The apparatus of claim 1, further comprising:
a filter retainer mounted to the discharge opening.

3. The apparatus of claim 1, wherein the discharge opening is structured to receive and retain a disc-shaped filter.

4. The apparatus of claim 1, wherein a volume of the brewing chamber is between 20 cm³ to 120 cm³.

5. The apparatus of claim 1, wherein a volume of the brewing chamber corresponds to between 1 to 10 times the volume of a single serving size of coffee grounds.

6. The apparatus of claim 1, wherein the upper reservoir and the brewing chamber are insulated.

7. The apparatus of claim 1, further comprising:
an exterior sidewall that tapers downwardly and inwardly from the upper opening to the discharge opening.

8. The apparatus of claim 1, wherein the discharge opening has a diameter that is equal to or greater than the diameter of the middle opening.

9. The apparatus of claim 1, wherein the brewing chamber is removably mounted to the upper reservoir.

10. The apparatus of claim 1, wherein the pour-over coffee maker is structured to drain a poured liquid from the upper reservoir and the discharge opening of the brewing chamber under the force of gravity.

11. The apparatus of claim 1, wherein the pour-over coffee maker is structured to extract liquid through the brewing chamber at an increased liquid flow rate relative to a liquid flow rate of the liquid flowing into and out of the brewing chamber.
